(19) United States
(12) Patent Application Publication
(10) Pub. No.: US 2008/0013016 A1
(43) Pub. Date: Jan. 17, 2008

(54) Liquid Crystal Display Device, Driving Method Thereof And Mobile Station Having The Same

(76) Inventors: Hyun Ha Hwang, Kangnam-gu (KR); Sung Ho Kim, Suwon-shi (KR)

Correspondence Address: SALIWANCHIK LLOYD & SALIWANCHIK;A PROFESSIONAL ASSOCIATION, PO BOX 142950, GAINESVILLE, FL, 32614-2950, US

(21) Appl. No.: 11/815,170

(22) PCT Filed: Feb. 17, 2006
(86) PCT No.: PCT/KR06/00540

§ 371 Date: Jul. 31, 2007

(30) Foreign Application Priority Data
Feb. 25, 2005 (KR) 10-2005-0015737

(51) Int. Cl. G02F 1/13357

(52) U.S. Cl. 349/70; 349/61

(57) ABSTRACT

A liquid crystal display device includes a transmissive liquid crystal panel having no color filter, a first front light unit disposed on front side of the transmissive liquid crystal panel to sequentially irradiate red, green, and blue light, and a second front light unit disposed on rear side of the transmissive liquid crystal panel to sequentially irradiate red, green, and blue light.

### TECHNICAL FIELD

The present invention relates to a liquid crystal display device capable of displaying an image on both front and rear surfaces of a liquid crystal panel using one transmissive liquid crystal panel, a driving method thereof, and a mobile station having the same.

### BACKGROUND ART

Among display devices for displaying an image on a screen, a Braun tube display device (or, cathode ray tube (CRT)) has been most popularly used. However, the CRT has several disadvantages that it is bulky and heavy in comparison with its display area.

Accordingly, a thin film type flat panel display device, which can be easily used anywhere because of its slimness, has been developed, and is gradually substituting the Braun tube display device. In particular, a liquid crystal display device has an excellent resolution in comparison with other flat panel display devices, and the response time of the LCD device has become almost as fast as the Braun tube display device, when displaying moving pictures.

The principles of the optical anisotropy and polarization of liquid crystals are employed in driving such an LCD device. The liquid crystal has an elongate structure, and it has a direction and a polarizability of a molecule array. Accordingly, the direction of the molecule array can be controlled by artificially applying an electric field to the liquid crystal. When the alignment direction is controlled by such an electric field, a light is transmitted or blocked according to the alignment direction of the liquid crystal molecules due to the optical anisotropy of the liquid crystal, thereby displaying colors and images.

In an active matrix LCD, an active device with a nonlinear characteristic is added into each of pixels arranged in a shape of matrix. Thus, an operation of each pixel is controlled using a switching characteristic of this active device.

Meanwhile, in recent years, various researches for a dual display have been undertaken, which is capable of displaying an image on both front and rear surface thereof.

### DISCLOSURE OF INVENTION

Technical Problem

The present invention is to provide an LCD capable of displaying an image on both front and rear surfaces of a liquid crystal panel using one transmissive liquid crystal panel and a driving method thereof.

And the present invention is to provide a slim type mobile station capable of displaying an image on both front and rear surfaces of an LCD using the LCD having one transmissive liquid crystal panel.

Technical Solution

The present invention provides an LCD including: a transmissive liquid crystal panel having no color filter; a first front light unit disposed on a front side of the transimissive liquid crystal panel to irradiate red, green, and blue light; and a second front light unit disposed on a rear side of the transmissive liquid crystal panel to irradiate red, green, and blue light.

The present invention provides a driving method of a liquid crystal display device, which includes a transmissive liquid crystal panel having no color filter, a first front light unit disposed on a front side of the transmissive liquid crystal panel to supply red, green, and blue light, and a second front light unit disposed on a rear side of the transmissive liquid crystal panel to supply red, green, and blue light the driving method includes driving the liquid crystal display device in a first display mode displaying an image corresponding to one frame on the rear surface of the transmissive liquid crystal panel using irradiated red, green, and blue light from the first front light unit and a second display mode displaying an image corresponding to one frame on the front surface of the transmissive liquid crystal panel using irradiated red, green, and blue light from the second front light unit.

The present invention provides a mobile station including: an LCD having a transmissive liquid crystal panel having no color filter, a first front light unit disposed on front side of the transimissive liquid crystal panel to irradiate red, green, and blue light, and a second front light unit disposed on rear side of the transmissive liquid crystal panel to irradiate red, green, and blue light; a communication unit for communicating with the exterior; and a control unit controlling the communication unit and an image display of the LCD.

Advantageous Effects

According to the present invention, there is provided the LCD capable of displaying an image on both front and rear surfaces of a liquid crystal panel using one transmissive liquid crystal panel and a driving method thereof.

And according to the present invention, there is provided a slim type mobile station capable of displaying an image on both front and rear surfaces of an LCD using the LCD having one transmissive liquid crystal panel.

### BRIEF DESCRIPTION OF THE DRAWINGS

FIG. 1 is a schematic view illustrating a constitution of an LCD according to the present invention.

FIG. 2 is a view illustrating an image display using a light supplied from a second front light unit, in the LCD according to the present invention.

FIG. 3 is a view illustrating an image display using a light supplied from a first front light unit, in the LCD according to the present invention.

FIG. 4 is a view illustrating a driving signal of a front light unit and a data signal applied to the LCD according to the present invention.

FIGS. 5 and 6 are views illustrating an opening ratio difference between a related art LCD and the LCD according to the present invention.

### MODE FOR THE INVENTION

Hereinafter, embodiments of the present invention will be described in detail with reference to accompanying drawings.

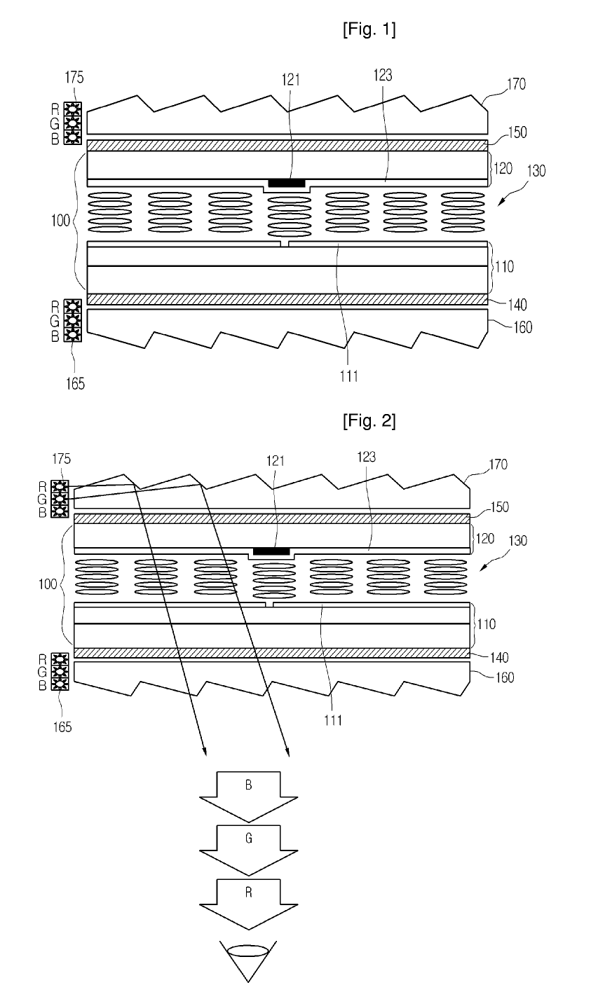

FIG. 1 is a schematic view illustrating a constitution of an LCD according to the present invention.

The LCD according to the present invention, as illustrated in FIG. 1, includes a transmissive liquid crystal panel 100, and a first front light unit 170 and a second front light unit 160 supplying a light for an image display.

The LCD according to the present invention can display an image on rear surface of the transmissive liquid crystal panel 100 by driving the first front light unit 170 disposed in front of the transmissive liquid crystal panel 100. Also, the LCD according to the present invention can display an image on front surface of the transmissive liquid crystal panel 100 by driving the second front light unit 160 disposed in rear side of the transmissive liquid crystal panel 100. Accordingly, an image can be displayed on both and rear surfaces of the transmissive liquid crystal panel 100.

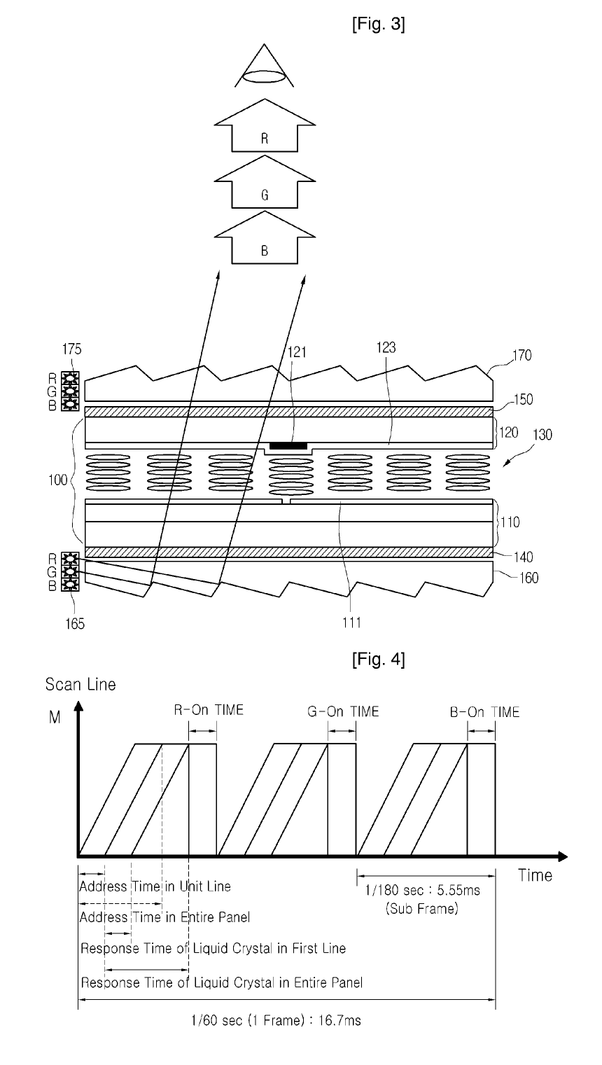

More specifically, as illustrated in FIG. 2, the LCD according to the present invention can be driven in a first display mode displaying an image on rear surface of the transmissive liquid crystal panel 100 using sequentially irradiated red, green light, and blue light from the first front light unit 170. Also, as illustrated in FIG. 3, the LCD according to the present invention can be driven in a second display mode displaying an image on front surface of the transmissive liquid crystal panel 100 using sequentially irradiated red, green, and blue light from the second front light unit 160.

The present invention employs the transmissive liquid crystal panel 100 having no color filter. A first light source 175 and a second light source 165 are provided respectively in the first front light unit 170 and the second front light unit 160. The first light source 175 and the second light source 165 are formed so as to supply red, green, and blue light. For example, the first light source 175 and the second light source 165 may include a red light emitting diode (LED), a green LED, and a blue LED, or include a red cold cathode fluorescent lamp (CCFL), a green CCFL, and a blue CCFL.

As described above, red, green, and blue light is supplied from the first front light unit 170 and the second front light unit 160, such that the LCD according to the present invention can display a color image without a color filter. That is, a desired color image can be displayed by irradiating sequentially supplied red, green, and blue light from the first front light unit 170 and the second front light unit 160 at certain intervals. A driving method of the LCD will be described more specifically later.

Meanwhile, the LCD is configured with a first substrate 110, a second substrate 120, a liquid crystal layer 130, a first polarizer 140, and a second polarizer 150. Since detail illustrations for these elements are well known already, explanations will be schematically described herein.

The first substrate 110 is configured with an array device having a thin film transistor, and a pixel electrode 111 formed on the array device to display an image by transmitting an incident light.

The array device includes a plurality of gate lines formed in a first direction, a plurality of data lines formed perpendicular to the gate lines, a pixel region defined by the gate line and the data line, and a thin film transistor formed at a region where the gate line and the data line are intersected with each other. Herein, a semiconductor layer constituting the thin film transistor may be formed of an amorphous silicon layer or a poly-silicon layer. Since a number of studies have been performed about processes of manufacturing a thin film transistor using an amorphous silicon layer or a polysilicon layer, explanations for the method will be omitted.

In addition, the second substrate 120 is disposed opposite to the first substrate 110.

The second substrate 120 includes a black matrix 121 formed opposite to a portion between the pixel electrodes 111 of the first substrate 110, and a common electrode 123 formed under the black matrix 121 and/or the second substrate 120.

The liquid crystal layer 130 is filled between the first and second substrates 110 and 120. The first polarizer 140 and the second polarizer 150 are disposed respectively under the first substrate 110 and on the second substrate 120.

Herein, the polarizers 140 and 150 may include a quarter-wave plate.

A driving method of the LCD having the above structure will be set forth with reference to FIG. 4. FIG. 4 is a view illustrating a driving signal of the front light unit and a data signal applied to the LCD according to the present invention.

In FIG. 4, turn-on times of red/green/blue light sources of the front light unit for displaying a color image is illustrated considering a response time of the liquid crystal panel. When applying such a field sequential driving, a time, for which red, green, and blue light sources are turned on, need to be made longer in order to increase the brightness. In this case, it is advantageous that an address time and a response time of the liquid crystal are short.

However, there are limits to decrease of the address time, which is defined by a driving circuit and a resolution. Accordingly, when applying the field sequential driving, in general, it tends to make a response time of the liquid crystal as high as possible. Accordingly, the response time of the liquid crystal should be higher than 5.55 ms assigned to a sub frame in driving at 180 Hz so as to display an image by a normal field sequential driving.

When applying such a field sequential driving type, red, green, blue light sources provided in the front light unit are sequentially driven. The incident red, green, and blue light by sequential driving of each light sources are transmitted through an opening portion (pixel region), such that red, green, and blue colors are sequentially displayed. The red, green, and blue colors are displayed in the pixel region at a time interval, and the time interval is called ‘a field’. The field sequential driving type means that colors are displayed by driving sequentially red, green, and blue light sources.

In the field sequential driving type LCD, a frame applied to a related art LCD is divided into three fields, and red, green, and blue light is irradiated to the liquid crystal panel from the front light unit during each fields. Generally, a time interval of one frame of the LCD driving at 60 Hz is 16.7 ms( 1/60 s). Accordingly, a field of the field sequential driving type has a time interval of 5.55 ms( 1/180 s). This time interval is so short, that human's eye can not feel the change in the field of such a short time interval. Therefore, human's eye recognizes the field changes as a combined time of 16.7 ms, such that a combined color of red, green, and blue can be recognized.

As described above, since the LCD according to the present invention includes light sources respectively emitting red, green, and blue light, the LCD can display a color image without a color filter. Accordingly, since an image is displayed using the liquid crystal panel without a color filter, light absorption by a color filter is not generated, thereby displaying an image with a high brightness.

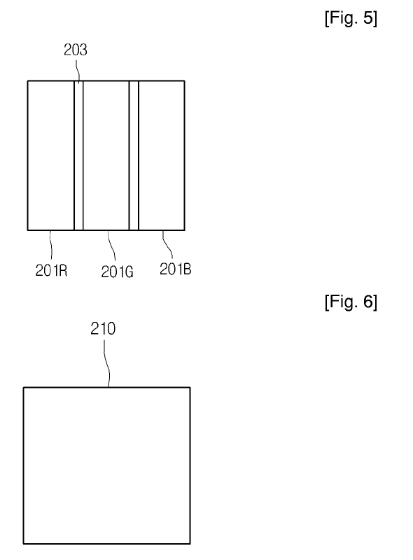

Also, according to the present invention, because a unit pixel is not divided into subpixels of R, G and B, an opening ratio increases, and an image with a high resolution is displayed. This will be described with reference to FIGS. 5 and 6. FIGS. 5 and 6 are views illustrating an opening ratio difference between a related art LCD and the LCD according to the present invention.

In the related art LCD having a color filter, as illustrated in FIG. 5, three subpixels 201R, 201G and 201B displaying red, green, and blue color configure one unit pixel. In addition, a black matrix 203 is formed between the subpixels 201R, 201G and 201B. However, in the LCD according to the present invention, as illustrated in FIG. 6, a unit pixel 210 of a single structure can be formed without the subpixels of red, green, and blue color and the black matrix. Therefore, in the LCD according to the present invention, an opening ratio increases, and size of the unit pixel decreases, and thus it becomes easier to design the LCD with a high resolution.

Also, according to the present invention, the number of driving devices can decrease by driving the unit pixel corresponding to the related R, G and B subpixel, without driving each subpixels of R, G and B.

Meanwhile, the LCD having the above structure may be utilized as a dual display device. Accordingly, if applying the inventive LCD to the mobile station such as a mobile communication terminal, a personal digital assistant (PDA) or the like, the image can be displayed on both front and rear surfaces of the liquid crystal panel. Therefore, it is possible to implement various image display functions in the mobile station.

The mobile station includes the LCD described above, a communication unit communicating with the exterior, and a control unit controlling the communication unit and an image display of the LCD. Elements of the mobile station and functions thereof are well known, descriptions about this in detail will be omitted.

### INDUSTRIAL APPLICABILITY

According to the LCD of the present invention and a driving method thereof, there is an advantage of displaying an image on both front and rear surfaces of a liquid crystal panel using one liquid crystal panel.

Also, according to the present invention, there is another advantage of generating no light absorption by a color filter and displaying an image with a high brightness by using a liquid crystal panel without a color filter.

Also, according to the present invention, there is another advantage of increasing an opening ratio and displaying an image with a high resolution because a unit pixel is not divided into each subpixels of R, G and B.

Also, according to the present invention, there is another advantage of decreasing the number of driving devices of a data line to 1/3 by driving a unit pixel corresponding to related art subpixelss of R, G and B without driving each subpixels of R, G, and B.

Also, according to the mobile station of the present invention, there is another advantage of providing a slim type mobile station capable of displaying an image on both surfaces of an LCD, using the LCD having one liquid crystal panel.

1. A liquid crystal display device comprising:
a transmissive liquid crystal panel provided with no color filter;
a first front light unit disposed on a front side of the transmissive liquid crystal panel to irradiate red, green, and blue light;
a second front light unit disposed on a rear side of the transmissive liquid crystal panel to irradiate red, green, and blue light.

2. The liquid crystal display device according to claim 1, wherein the first front light unit performs a first display mode operation of displaying an image on the rear surface of the transmissive liquid crystal panel using a sequentially irradiated red, green, and blue light from the first front light unit, and
the second front light unit performs a second display mode displaying an image on the front surface of the transmissive liquid crystal panel using a sequentially irradiated red, green, and blue light from the second front light unit.

3. The liquid crystal display device according to claim 1, wherein the first front light unit and the second front light unit include red, green, and blue light sources.

4. The liquid crystal display device according to claim 1, wherein the first front light unit and the second front light unit include red, green, and blue light emitting diodes.

5. The liquid crystal display device according to claim 1, wherein the first front light unit and the second front light unit include red, green, and blue cold cathode fluorescent lamps (CCFLs).

6. The liquid crystal display device according to claim 1, wherein the transmissive liquid crystal panel comprises:
a first substrate comprising an array device and a pixel electrode formed on the array device to display an image by transmitting an incident light;
a second substrate formed opposite the first substrate, the second substrate comprising a black matrix to a portion between the pixel electrodes of the first substrate; and
a liquid crystal layer filled between the first substrate and the second substrate.

7. The liquid crystal display device according to claim 6, wherein the array device comprises:
a plurality of gate lines formed in a first direction;
a plurality of data lines formed perpendicular to the gate lines;
a pixel region defined by a gate line and a data line of the plurality of gate lines and the plurality of data lines respectively; and
a thin film transistor formed at a region where the gate line and the data line intersect with each other.

8. The liquid crystal display device according to claim 1, wherein the transmissive liquid crystal panel has a response time of about 5.55 ms.

9. The liquid crystal display device according to claim 1, wherein a semiconductor layer of the transmissive liquid crystal panel is formed of an amorphous silicon layer or poly-silicon layer.

10. The liquid crystal display device according to claim 1, wherein the transmissive liquid crystal panel comprises polarizers formed on the front and rear surfaces thereof.

11. A driving method of a liquid crystal display device, wherein the liquid crystal display device comprises a transmissive liquid crystal panel provided with no color filter; a first front light unit disposed on a front side of the transmissive liquid crystal panel to supply red, green, and blue light; and a second front light unit disposed on a rear side of the transmissive liquid crystal panel to supply red, green, and blue light, the method comprising:
driving the liquid crystal display device in a first display mode displaying an image corresponding to one frame on the rear surface of the transmissive liquid crystal panel using irradiated red, green, and blue light from the first front light unit; and
driving the liquid crystal display device in a second display mode displaying an image corresponding to one frame on the front surface of the transmissive liquid crystal panel using irradiated red, green, and blue light from the second front light unit.

12. The method according to claim 11, wherein the first front light unit and the second front light unit include red, green, and blue light sources.

13. The method according to claim 11, wherein the transmissive liquid crystal panel has a higher response time of about 5.55 ms.

14. The method according to claim 11, wherein the red, green, and blue light supplied from the first front light unit and the red, green, and blue light supplied from the second front light unit are sequentially irradiated at a time interval from each other to implement one image frame.

15. A mobile station comprising:
a liquid crystal display device including a transmissive liquid crystal panel provided with no color filter; a first front light unit disposed on a front side of the transmissive liquid crystal panel to irradiate red, green, and blue light; and a second front light unit disposed on a rear side of the transmissive liquid crystal panel to irradiate red, green, and blue light;
a communication unit communicating with the exterior; and
a control unit controlling the communication unit and an image display of the liquid crystal display device.

16. The mobile station according to claim 15, wherein the first front light unit performs a first display mode operation of displaying an image on the rear surface of the liquid crystal display device using a sequentially irradiated red, green, and blue light from the first front light unit; and
the second front light unit performs a second display mode operation of displaying an image on the front surface of the liquid crystal display device using a sequentially irradiated red, green, and blue light from the second front light unit.

17. The mobile station according to claim 15, wherein the transmissive liquid crystal panel has a response time of about 5.55 ms.

18. The mobile station according to claim 15, wherein the transmissive liquid crystal panel comprises polarizers formed on the front and rear surfaces thereof.
